(19) United States
(12) Patent Application Publication
(10) Pub. No.: US 2025/0310751 A1
(43) Pub. Date: Oct. 2, 2025

(54) SIGNAL COVERAGE INFORMATION DETERMINATION METHOD AND APPARATUS, COMMUNICATION DEVICE AND STORAGE MEDIUM

(71) Applicant: BEIJING XIAOMI MOBILE SOFTWARE CO., LTD., Beijing (CN)

(72) Inventor: Wei LU, Beijing (CN)

(73) Assignee: BEIJING XIAOMI MOBILE SOFTWARE CO., LTD., Beijing (CN)

(21) Appl. No.: 18/864,751

(22) PCT Filed: May 13, 2022
(86) PCT No.: PCT/CN2022/092840

§ 371 Date: Nov. 11, 2024

(51) Int. Cl. H04W 8/18; H04W 76/30; H04W 84/06

(52) U.S. Cl. CPC H04W 8/183; H04W 76/30; H04W 84/06

(57) ABSTRACT

Embodiments of the present disclosure relate to a signal coverage information determination method and apparatus, a communication device, and a storage medium. User equipment (UE) receives broadcast information carrying first signal coverage information sent by a non-terrestrial network (NTN) access network device; the UE receives a non-access stratum (NAS) message carrying second signal coverage information sent by a core network device, the NAS message being related to a configuration update of the UE; and the UE determines third signal coverage information to be adopted by the UE on the basis of the first signal coverage information and the second signal coverage information.

### TECHNICAL FIELD

The present disclosure relates to the field of wireless communication technology, but is not limited to the field of wireless communication technology, and in particular to a signal coverage information determining method and apparatus, a communication device and a storage medium.

### BACKGROUND

The 5th Generation Core (5GC)/Evolved Packet Core (EPC) enhancements can support satellite access with discontinuous satellite coverage. To support power saving based on Access and Mobility management Function (AMF) awareness of signal coverage information, AMF may trigger the Access Network (AN) release procedure to move a User Equipment (UE) into a Connection Management IDLE (CM-IDLE) and transmit power saving parameters.

### SUMMARY

In view of this, the embodiments of the present disclosure provide a signal coverage information determining method and apparatus, a communication device and a storage medium.

According to the first aspect of the embodiments of the present disclosure, a signal coverage information determining method is provided, where the method is performed by a user equipment (UE), and the method includes:

receiving broadcast information carrying first signal coverage information transmitted by a Non-Terrestrial Networks-Radio Access Network (NTN-RAN) device;

receiving a Non-Access Stratum (NAS) message carrying second signal coverage information transmitted by a core network device, where the NAS message is related to a configuration update of the UE; and

determining, based on the first signal coverage information and the second signal coverage information, third signal coverage information to be used by the UE.

In an embodiment, receiving the NAS message carrying the second signal coverage information transmitted by the core network device includes:

receiving a UE configuration update message carrying the second signal coverage information transmitted by the core network device.

In an embodiment, determining, based on the first signal coverage information and the second signal coverage information, the third signal coverage information to be used by the UE includes:

determining, in response to the first signal coverage information and the second signal coverage information being same, the first signal coverage information as the third signal coverage information; or

determining, in response to the first signal coverage information and the second signal coverage information being different, the second signal coverage information as the third signal coverage information.

In an example, the method further includes:

releasing an access network connection based on an access network connection release request transmitted by the NTN-RAN device.

According to the second aspect of the embodiments of the present disclosure, a signal coverage information determining method is provided, where the method is performed by a core network device, and the method includes:

obtaining second signal coverage information;

transmitting a Non-Access Stratum (NAS) message carrying the second signal coverage information to a user equipment (UE), where the NAS message is related to a configuration update of the UE, where the second signal coverage information is used to be compared, by the UE, with first signal coverage information determined by the UE from broadcast information, for determining third signal coverage information to be used by the UE based on a comparison result.

In an embodiment, transmitting a (Non-Access Stratum) NAS message carrying second signal coverage information to the UE includes:

transmitting a UE configuration update message carrying the second signal coverage information to the UE.

In an embodiment, obtaining the second signal coverage information includes at least one of the following:

receiving the second signal coverage information transmitted by a Non-Terrestrial Networks-Radio Access Network (NTN-RAN) device; or

obtaining the second signal coverage information pre-stored from an (Operation Administration and Maintenance) OAM network element.

In an embodiment, receiving the second signal coverage information transmitted by the NTN-RAN device includes:

receiving a context release request message carrying the second signal coverage information transmitted by the NTN-RAN device.

In an example, the method further includes:

transmitting an N2 UE context release command to an NTN-RAN device, where the N2 UE context release command is configured to trigger the NTN-RAN device to transmit an access network connection release request to the UE, where the access network connection release request instructs the UE to release an access network connection.

According to the third aspect of the embodiments of the present disclosure, a signal coverage information determining method is provided, where the method is performed by an NTN-RAN device, and the method includes:

transmitting broadcast information carrying fourth signal coverage information to a user equipment (UE), where signal coverage information transmitted to the UE is used for the UE to determine first signal coverage information; and

transmitting the fourth signal coverage information to a core network device, where the fourth signal coverage information transmitted to the core network device is used for the core network device to determine second signal coverage information, where the second signal coverage information is carried in a Non-Access Stratum (NAS) message and transmitted to the UE by the core network device, and the second signal coverage information is used to be compared, by the UE, with the first signal coverage information for determining third signal coverage information to be used by the UE based on a comparison result, where the NAS message is related to a configuration update of the UE.

In an embodiment, transmitting the fourth signal coverage information to the core network device includes:

transmitting a context release request message carrying the fourth signal coverage information to the core network device.

In an example, the method further includes:

receiving an N2 UE context release command transmitted by the core network device; and

transmitting, according to the N2 UE context release command, an access network connection release request to the UE for instructing the UE to release an access network connection.

According to the fourth aspect of the disclosed embodiment, a signal coverage information determining apparatus is provided, where the apparatus includes:

a first transceiving module, configured to receive broadcast information carrying first signal coverage information transmitted by a Non-Terrestrial Networks-Radio Access Network (NTN-RAN) device;

where the first transceiving module is further configured to receive a Non-Access Stratum (NAS) message carrying second signal coverage information transmitted by a core network device, where the NAS message is related to a configuration update of a user equipment (UE); and

a processing module, configured to determine, based on the first signal coverage information and the second signal coverage information, third signal coverage information to be used by the UE.

In an embodiment, the first transceiving module is specifically configured to:

receive a UE configuration update message carrying the second signal coverage information transmitted by the core network device.

In an embodiment, the processing module is specifically configured to:

determine, in response to the first signal coverage information and the second signal coverage information being same, the first signal coverage information as the third signal coverage information; or

determine, in response to the first signal coverage information and the second signal coverage information being different, the second signal coverage information as the third signal coverage information.

In an embodiment, the processing module is further configured to:

release an access network connection based on an access network connection release request transmitted by the NTN-RAN device.

According to the fifth aspect of the disclosed embodiment, a signal coverage information determining apparatus is provided, where the apparatus includes:

a second transceiving module, configured to obtain second signal coverage information;

where the second transceiving module is configured to transmit a Non-Access Stratum (NAS) message carrying the second signal coverage information to a user equipment (UE), where the NAS message is related to a configuration update of the UE, where the second signal coverage information is used to be compared, by the UE, with first signal coverage information determined by the UE from broadcast information, for determining third signal coverage information to be used by the UE based on a comparison result.

In an embodiment, the second transceiving module is specifically configured to:

transmit a UE configuration update message carrying the second signal coverage information to the UE.

In an embodiment, the second transceiving module is further configured to at least one of:

receive the second signal coverage information transmitted by a Non-Terrestrial Networks-Radio Access Network (NTN-RAN) device; or

obtain the second signal coverage information pre-stored from an (Operation Administration and Maintenance) OAM network element.

In an embodiment, the second transceiving module is specifically configured to:

receive a context release request message carrying the second signal coverage information transmitted by the NTN-RAN device.

In an embodiment, the second transceiving module is further configured to transmit an N2 UE context release command to an NTN-RAN device, where the N2 UE context release command is configured to trigger the NTN-RAN device to transmit an access network connection release request to the UE, where the access network connection release request instructs the UE to release an access network connection.

According to the sixth aspect of the disclosed embodiment, a signal coverage information determining apparatus is provided, where the apparatus includes:

a third transceiving module, configured to transmit broadcast information carrying fourth signal coverage information to a user equipment (UE), where signal coverage information transmitted to the UE is used for the UE to determine first signal coverage information;

where the third transceiving module is further configured to transmit the fourth signal coverage information to a core network device, where the fourth signal coverage information transmitted to the core network device is used for the core network device to determine second signal coverage information, where the second signal coverage information is carried in a Non-Access Stratum (NAS) message and transmitted to the UE by the core network device, and the second signal coverage information is used to be compared, by the UE, with the first signal coverage information for determining third signal coverage information to be used by the UE based on a comparison result, where the NAS message is related to a configuration update of the UE.

In an embodiment, the third transceiving module is specifically configured to:

transmit a context release request message carrying the fourth signal coverage information to the core network device.

In an embodiment, the third transceiving module is further configured to:

receive an N2 UE context release command transmitted by the core network device; and

transmit, according to the N2 UE context release command, an access network connection release request to the UE for instructing the UE to release an access network connection.

According to the seventh aspect of the embodiments of the present disclosure, a communication device is provided, including one or more processors, one or more memories, and an executable program stored on the one or more memories and executable by the one or more processors, where the one or more processors, when running the executable program, implement the signal coverage information determining method as described in the first aspect, or the second aspect, or the third aspect.

According to the eighth aspect of the embodiments of the present disclosure, a storage medium storing an executable program is provided, where when the executable program is executed by one or more processors, the signal coverage information determining method as described in the first aspect, or the second aspect, or the third aspect is implemented.

In the signal coverage information determining method and apparatus, communication device, and storage medium provided in the embodiments of the present disclosure, the UE receives broadcast information carrying the first signal coverage information transmitted by the NTN-RAN device, and receives an NAS message carrying the second signal coverage information transmitted by the core network device, where the NAS message is related to a configuration update of the UE. Based on the first signal coverage information and the second signal coverage information, the third signal coverage information to be used by the UE is determined. In this way, by comparing the first signal coverage information with the second signal coverage information obtained through a secure transmission method, it is determined whether the first signal coverage information is correct, and then based on the determined true third signal coverage information of the satellite, communication is carried out with the NTN-RAN device to improve communication security, which can reduce the situation where incorrect signal coverage information is used to mislead the UE to stop working within the actual network coverage, or to reduce unnecessary power consumption caused by the UE continuing to transmit signals to access the network beyond the actual network coverage.

It is to be understood that the above general descriptions and the below detailed descriptions are merely exemplary and explanatory, and are not intended to limit the present disclosure.

### BRIEF DESCRIPTION OF DRAWINGS

The accompanying drawings are incorporated in and constitute a part of the present description, illustrate embodiments consistent with the present disclosure and serve to explain the principles of the embodiments in present disclosure together with the description.

FIG. 1 is a schematic structural diagram of a wireless communication system according to an embodiment.

FIG. 2 is a flowchart of a signal coverage information determining method according to an embodiment.

FIG. 3 is a flowchart of a signal coverage information determining method according to another embodiment.

FIG. 4 is a flowchart of a signal coverage information determining method according to still another embodiment.

FIG. 5 is a schematic diagram of information interaction for a signal coverage information determining method according to yet another embodiment.

FIG. 6 is a schematic diagram of information interaction for a signal coverage information determining method according to yet another embodiment.

FIG. 7 is a schematic diagram of information interaction for a signal coverage information determining method according to yet another embodiment.

FIG. 8 is a schematic diagram of information interaction for a signal coverage information determining method according to yet another embodiment.

FIG. 9 is a block diagram of a signal coverage information determining apparatus according to an embodiment.

FIG. 10 is a block diagram of a signal coverage information determining apparatus according to another embodiment.

FIG. 11 is a block diagram of a signal coverage information determining apparatus according to still another embodiment.

FIG. 12 is a block diagram of a device for signal coverage information determination according to an embodiment.

### DETAILED DESCRIPTION

Embodiments will be described in detail here with the examples thereof expressed in the drawings. When the following descriptions involve the drawings, like numerals in different drawings represent like or similar elements unless stated otherwise. Implementations described in the following embodiments do not represent all implementations consistent with the present disclosure. On the contrary, they are examples of an apparatus and a method consistent with some aspects of the present disclosure described in detail in the appended claims.

The term used in the embodiments of the present disclosure is for the purpose of describing particular examples only and is not intended to limit the embodiments of the present disclosure. As used in the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish one category of information from another. For example, without departing from the scope of the present disclosure, first information may be referred as second information; and similarly, second information may also be referred as first information. Depending on the context, the word “if” as used herein can be interpreted as “at the time of”, “when” or “in response to determining”.

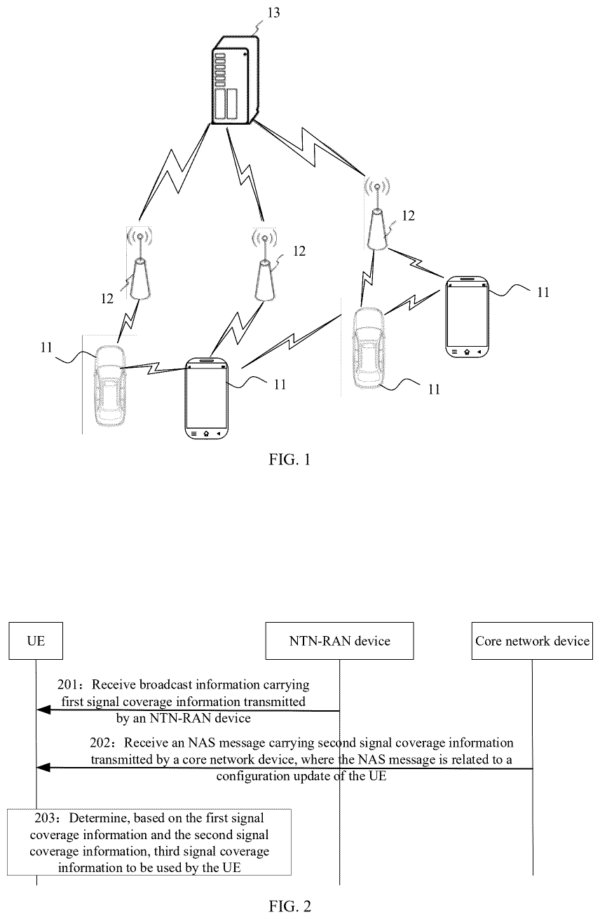

Referring to FIG. 1, a schematic structural diagram of a wireless communication system according to an embodiment is illustrated. As shown in FIG. 1, a wireless communication system is a communication system based on cellular mobile communication technology, the wireless communication system may include: several terminals 11 and several base stations 12.

The terminals 11 may be devices providing voice and/or data connectivity to users. The terminals 11 may communicate with one or more core networks via a Radio Access Network (RAN) and may be IoT terminals such as sensor devices, mobile phones (also called cellular phones) and computers with IoT terminals, for example, fixed, portable, pocket-sized, handheld, computer-built or vehicle-mounted devices. For example, Stations (STAs), subscriber units, subscriber stations, mobile stations, mobiles, remote stations, access points, remote terminals, access terminals, user terminals, user agents, user devices, or user equipments. Or the terminals 11 may also be unmanned aerial vehicle devices. Or the terminals 11 can also be vehicle-mounted devices, for example, trip computers with wireless communication capabilities, or wireless communication devices external to trip computers. Or the terminals 11 can be infrastructures, such as street lights, signal lights or other infrastructures with wireless communication capabilities and the like.

The base stations 12 may be network side devices in the wireless communication system. The wireless communication system may be a 4th generation mobile communication (4G) system, also known as a Long-Term Evolution (LTE) system, or the wireless communication system may be a 5G system, also known as a New Radio (NR) system or 5G NR system. Or the wireless communication system may be a next-generation system to the 5G system. One of the access networks in the 5G system can be known as the NG-RAN (New Generation-Radio Access Network), or the MTC system.

The base stations 12 can be evolved base stations (eNBs) as adopted in 4G systems. Or the base stations 12 can also be base stations (gNBs) in a 5G system with a centralized and distributed architecture. When the base stations 12 adopt the centralized and distributed architecture, a central unit (CU) and at least two distributed units (DU) are usually included. A Packet Data Convergence Protocol (PDCP) layer, a Radio Link Control (RLC) layer, and a Media Access Control (MAC) layer protocol stack are provided in the central unit; a Physical (PHY) layer protocol stack is provided in the distributed unit, and embodiments of the present disclosure do not limit the specific implementation of the base stations 12.

The base stations 12 and the terminals 11 can be connected to each other via wireless air interfaces. In different implementations, the wireless air interfaces may be wireless air interfaces based on the fourth generation mobile communication network technology (4G) standard; or, the wireless air interfaces may be wireless air interfaces based on the fifth generation mobile communication network technology (5G) standard, for example, the wireless air interfaces may be New Radios; or, the wireless air interfaces may also be wireless air interfaces based on the next generation mobile communication network technology standard of 5G.

In some embodiments, an E2E (End to End) connection may also be established between the terminals 11. For example, in vehicle to everything (V2X) communication scenarios, such as V2V (vehicle to vehicle) communication, V2I (vehicle to infrastructure) communication, V2P (vehicle to pedestrian) communication and the like.

In some embodiments, the above wireless communication system may also include network management devices 13.

Several base stations 12 are connected to the network management devices 13 respectively. The network management devices 13 may be core network devices in the wireless communication system, for example, the network management devices 13 may be Mobility Management Entities (MMEs) in an Evolved Packet Core (EPC) network. Or, the network management devices may also be other core network devices such as Serving GateWays (SGW), Public Data Network GateWays (PGW), Policy and Charging Rules Function (PCRF) units, Home Subscriber Servers (HSS) and the like. The embodiments of the present disclosure do not limit the form in which the network management devices 13 can be implemented.

The AMF can detect the time when a UE leaves a current network coverage based on signal coverage information. The signal coverage information can be transmitted to the AMF by a Non-Terrestrial Networks-Radio Access Network (NTN-RAN) or an Operation Administration and Maintenance (OAM) system.

The signal coverage information is also transmitted to the UE by the NTN-RAN through the System Information Block (SIB) information. Since SIB information is unprotected broadcast information, the signal coverage information carried in the broadcast SIB information is easily tampered with by attackers. If the tampered signal coverage information distorts the actual network coverage, the tampered network coverage may mislead the UE to stop working within the actual network coverage, which is a Denial of Service (DOS) attack. Alternatively, the tampered network coverage may mislead the UE to continue transmitting signals to access the network beyond the actual network coverage, which results in unnecessary power consumption.

Therefore, how to verify whether the signal coverage information received by the UE has been tampered with, communicate based on the correct signal coverage information, and improve communication security is an urgent problem to be solved.

As shown in FIG. 2, this embodiment provides a signal coverage information determining method, which can be performed by a UE in a cellular mobile communication system, and includes steps 201 to 203.

In step 201, broadcast information carrying first signal coverage information transmitted by an NTN-RAN device is received.

In step 202, an NAS message carrying second signal coverage information transmitted by a core network device is received, where the NAS message is related to a configuration update of the UE.

In step 203, based on the first signal coverage information and the second signal coverage information, third signal coverage information to be used by the UE is determined.

This embodiment can be applied, but is not limited to, scenarios with discontinuous satellite signal coverage, which is not limited in the present disclosure.

The NTN-RAN device can include a satellite, or a base station, etc. in the NTN. In the NTN, a satellite can be used to provide a relay for signals of a base station, i.e., to provide signal coverage for the cellular mobile communication network to the ground. Alternatively, the satellite can also be an aerial base station in NTN, to provide signal coverage for the cellular mobile communication network to the ground.

Signal coverage information, i.e., satellite signal coverage information, can be used to determine the coverage of satellite signals at different times. The signal coverage information includes but is not limited to at least one of the following: ephemeris information of a satellite, a center position of satellite signal coverage, a radius of satellite signal coverage, or an area of satellite signal coverage, etc.

A UE can determine the location of the UE within the satellite signal coverage based on signal coverage information. For example, the UE can determine the current distance from the center point of the satellite signal coverage to the UE or the current distance from the edge of the satellite signal coverage to the UE based on the geographical location of the UE, satellite ephemeris, a center position of satellite signal coverage, and a radius of satellite signal coverage.

Furthermore, the UE can determine whether to access the network, perform data communication, and/or stop data communication.

The first signal coverage information may be the signal coverage information obtained by the UE from the broadcast information of the NTN-RAN device.

In an embodiment, the broadcast information may include but is not limited to system information broadcasted by the NTN-RAN device. The system information includes but is not limited to SIB. Signal coverage information herein can be configured by OAM on the NTN-RAN device.

The NTN-RAN device can carry the true signal coverage information (i.e., fourth signal coverage information) of a satellite in the broadcast information for broadcasting. Due to the possibility of erroneous transmission and/or tampering during the transmission of broadcast system information, the fourth signal coverage information transmitted by the NTN-RAN device may differ from the first signal coverage information obtained by UE from the broadcast information. The first signal coverage information may be the same as the fourth signal coverage information carried by the NTN-RAN device in the broadcast information, or the first signal coverage information may be different from the fourth signal coverage information carried by the NTN-RAN device in the broadcast information.

For example, since the broadcast system information is not tamper-protected, the fourth signal coverage information carried by the NTN-RAN device in the broadcast information may be tampered with, causing the first signal coverage information received by the UE to be different from the fourth signal coverage information.

The core network device herein can include AMF, etc. The core network device can obtain the second signal coverage information. The core network device can be set to obtain second signal coverage information through a protected channel to improve the reliability of the second signal coverage information.

In an embodiment, the core network device obtaining the second signal coverage information, includes at least one of the following:

the core network device receiving the second signal coverage information transmitted by a Non-Terrestrial Networks-Radio Access Network (NTN-RAN) device; or

the core network device obtaining the second signal coverage information pre-stored from an (Operation Administration and Maintenance) OAM network element.

The NTN-RAN device can carry fourth signal coverage information through an N2 message, and the core network device can obtain carried second signal coverage information from the N2 message. Since the N2 message is a protected message, there is a high probability that the fourth signal coverage information matches the second signal coverage information received by the core network device. It is generally believed that the fourth signal coverage information is protected by security measures during transmission, such as encryption protection and/or integrity protection. Therefore, the second signal coverage information received by the core network device is consistent with the fourth signal coverage information.

The second signal coverage information can also be pre-stored in the OAM network element. The core network device can directly obtain the second signal coverage information from the OAM. The second signal coverage information can be pre-stored in the OAM network element by the NTN-RAN device, etc.

Here, the UE Configuration Update (UCU) event can be performed by the core network device to trigger that the core network device transmits a message carrying the second signal coverage information to the UE.

When the UE leaves the current signal coverage, the core network can update the UE configuration for the UE, such as updating the power-saving parameters of the UE, based on the interval between the time the UE re-enters into the signal coverage and the time the UE leaves the signal coverage. The power-saving parameters may include at least one of: the starting time when the UE enters the power-saving mode, the starting time when the UE returns from the power-saving mode to the normal working mode, or the duration for which the UE maintains the power-saving mode. The power-saving mode may include the CM-IDLE status of the UE, etc. In the power-saving mode, the UE does not transmit any uplink signaling requests to save power.

The core network device can use a secure transmission method to transmit a message carrying second signal coverage information. Here, the secure transmission method may include using encryption protection and/or integrity protection to transmit messages. Since the message carrying the second signal coverage information is a protected message, it can be considered that the second signal coverage information has not been tampered with during transmission. The second signal coverage information can be considered as the true signal coverage information.

For example, the core network device can carry the second signal coverage information through an NAS message transmitted to the UE during the UE configuration update process. The NAS message is encrypted and/or integrity protected, which can reduce errors in the transmission of the second signal coverage information.

The UE can compare the first signal coverage information with the second signal coverage information to determine whether the received first signal coverage information is the true signal coverage information of the satellite.

The third signal coverage information can be determined based on whether the first signal coverage information is true signal coverage information. For example, if the first signal coverage information is true signal coverage information, the third signal coverage information can be determined based on the first signal coverage information. If the first signal coverage information is untrue signal coverage information, the second signal coverage information can be determined as the third signal coverage information.

The UE can determine its location within the satellite signal coverage based on the third signal coverage information, and then determine whether to perform data communication and/or stop data communication.

In this way, by comparing the first signal coverage information with the second signal coverage information obtained through a secure transmission method, it is determined whether the first signal coverage information is correct, and then based on the determined true third signal coverage information of the satellite, communication is carried out with the NTN-RAN device to improve communication security, which can reduce the situation where incorrect signal coverage information is used to mislead the UE to stop working within the actual network coverage, or to reduce unnecessary power consumption caused by the UE continuing to transmit signals to access the network beyond the actual network coverage.

In an embodiment, receiving the NAS message carrying the second signal coverage information transmitted by the core network device includes:

receiving a UE configuration update message carrying the second signal coverage information transmitted by the core network device.

For example, if the NTN-RAN device detects that the UE is to leave the current network coverage based on signal coverage information, the NTN-RAN device can trigger an AN release process to move the UE to the CM-IDLE state before the UE leaves the current network coverage. The NTN-RAN device transmits a context release request message (N2 UE Context Release Request) to AMF. In the N2 UE context release request message, the NTN-RAN can transmit the fourth signal coverage information to AMF. Since the N2 message is a protected message, it can be considered that the second signal coverage information obtained by AMF from the registration request message is consistent with the fourth signal coverage information. AMF can also obtain the second signal coverage information from OAM. AMF can store the obtained second signal coverage information.

If the NTN-RAN does not transmit signal coverage information to AMF, AMF can obtain the second signal coverage information from the OAM webpage. If AMF detects that the UE is to leave the current network coverage based on the second signal coverage information, when the UE is still within the network coverage, the AMF triggers the AN release process to move the UE to the CM-IDLE state. AMF can determine the power-saving parameters of UE based on signal coverage information. The power-saving parameters can indicate that the UE remains in the power-saving mode without waking up or transmitting any uplink signaling requests in the absence of network coverage.

AMF triggers the UE configuration update process to update power-saving parameters. AMF transmits a UE configuration update message to the UE. The UE configuration update message carries second signal coverage information. The UE configuration update message is an NAS message. The NAS message is protected by security measures. Therefore, the UE can correctly receive the second signal coverage information.

By carrying the second signal coverage information in the UE configuration update message, the accuracy of UE receiving the second signal coverage information can be improved, and the verification of the first signal coverage information can be achieved.

In an embodiment, determining, based on the first signal coverage information and the second signal coverage information, the third signal coverage information to be used by the UE includes:

determining, in response to the first signal coverage information and the second signal coverage information being same, the first signal coverage information as the third signal coverage information; or

determining, in response to the first signal coverage information and the second signal coverage information being different, the second signal coverage information as the third signal coverage information.

For example, the UE compares the first signal coverage information with the second signal coverage information. If the first signal coverage information is inconsistent with the second signal coverage information, the UE can use the second signal coverage information as the third signal coverage information. For example, the second signal coverage information can be used to cover the first signal coverage information stored by the UE. If the first signal coverage information is not consistent with the second signal coverage information, the UE can use the first signal coverage information as the third signal coverage information. For example, the first signal coverage information can be retained.

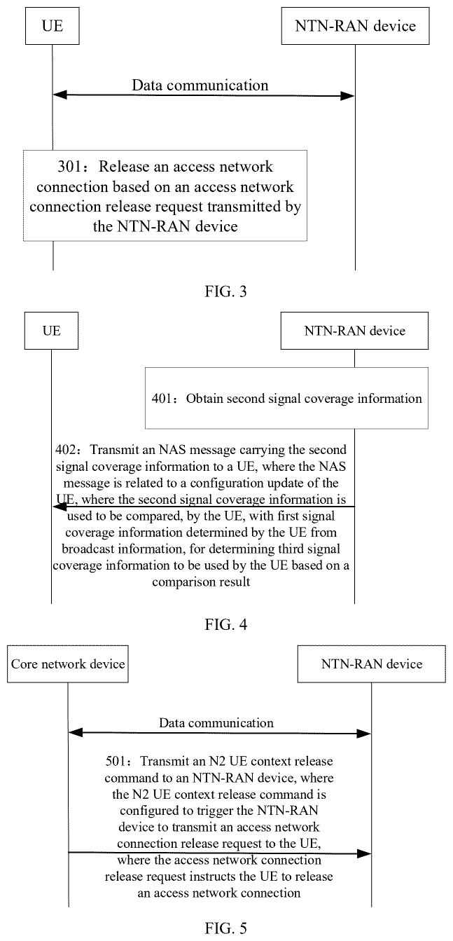

As shown in FIG. 3, this embodiment provides a signal coverage information determining method, which can be performed by a UE in a cellular mobile communication system, and includes step 301.

In step 301, an access network connection is released based on an access network connection release request transmitted by the NTN-RAN device.

Step 301 can be implemented separately or in combination with steps 201 to 203.

After the AMF transmits the UE configuration update message to the UE, the AMF can transmit the N2 UE Context Release Command to the NTN-RAN. After the N2 UE context release command is received by the NTN-RAN, the NTN-RAN can request the UE to release the access network connection through an access network connection release request. After the NTN-RAN receives the RAN connection release confirmation from the UE, the NTN-RAN deletes the context of the UE. The NTN-RAN confirms N2 release by returning an N2 UE Context Release Complete message to the AMF.

As shown in FIG. 4, this embodiment provides a signal coverage information determining method, which can be performed by a core network device in a cellular mobile communication system, and includes steps 401 and 402.

In step 401, second signal coverage information is obtained.

In step 402, an NAS message carrying the second signal coverage information is transmitted to a UE, where the NAS message is related to a configuration update of the UE, where the second signal coverage information is used to be compared, by the UE, with first signal coverage information determined by the UE from broadcast information, for determining third signal coverage information to be used by the UE based on a comparison result.

This embodiment can be applied, but is not limited to, scenarios with discontinuous satellite signal coverage, which is not limited in the present disclosure.

The core network device includes but is not limited to AMF.

The NTN-RAN device can include a satellite, or a base station, etc. in the NTN. In the NTN, a satellite can be used to provide a relay for signals of a base station, i.e., to provide signal coverage for the cellular mobile communication network to the ground. Alternatively, the satellite can also be an aerial base station in NTN, to provide signal coverage for the cellular mobile communication network to the ground.

Signal coverage information, i.e., satellite signal coverage information, can be used to determine the coverage of satellite signals at different times. The signal coverage information includes but is not limited to at least one of the following: ephemeris information of a satellite, a center position of satellite signal coverage, a coverage radius of satellite signals, or a coverage area of satellite signals, etc.

A UE can determine the location of the UE within the satellite signal coverage based on signal coverage information. For example, the UE can determine the current distance from the center point of the satellite signal coverage to the UE or the current distance from the edge of the satellite signal coverage to the UE based on the geographical location of the UE, satellite ephemeris, a center position of satellite signal coverage, and a radius of satellite signal coverage. Furthermore, the UE can determine whether to access the network, perform data communication, and/or stop data communication.

The first signal coverage information may be the signal coverage information obtained by the UE from the broadcast information of the NTN-RAN device.

In an embodiment, the broadcast information may include but is not limited to system information broadcasted by the NTN-RAN device. The system information includes but is not limited to SIB. Signal coverage information herein can be configured by OAM on the NTN-RAN device.

The NTN-RAN device can carry the true signal coverage information (i.e., fourth signal coverage information) of a satellite in the broadcast information for broadcasting. Due to the possibility of erroneous transmission and/or tampering during the transmission of broadcast system information, the fourth signal coverage information transmitted by the NTN-RAN device may differ from the first signal coverage information obtained by UE from the broadcast information. The first signal coverage information may be the same as the fourth signal coverage information carried by the NTN-RAN device in the broadcast information, or the first signal coverage information may be different from the fourth signal coverage information carried by the NTN-RAN device in the broadcast information.

For example, since the broadcast system information is not tamper-protected, the fourth signal coverage information carried by the NTN-RAN device in the broadcast information may be tampered with, causing the first signal coverage information received by the UE to be different from the fourth signal coverage information.

The core network device herein can include AMF, etc. The core network device can obtain the second signal coverage information. The core network device can be set to obtain second signal coverage information through a protected channel to improve the reliability of the second signal coverage information.

In an embodiment, obtaining the second signal coverage information includes at least one of the following:

receiving the second signal coverage information transmitted by a Non-Terrestrial Networks-Radio Access Network (NTN-RAN) device; or

obtaining the second signal coverage information pre-stored from an (Operation Administration and Maintenance) OAM network element.

The NTN-RAN device can carry fourth signal coverage information through an N2 message, and the core network device can obtain carried second signal coverage information from the N2 message. Since the N2 message is a protected message, there is a high probability that the fourth signal coverage information matches the second signal coverage information received by the core network device. It is generally believed that the fourth signal coverage information is protected by security measures during transmission, such as encryption protection and/or integrity protection. Therefore, the second signal coverage information received by the core network device is consistent with the fourth signal coverage information.

The second signal coverage information can also be pre-stored in the OAM network element. The core network device can directly obtain the second signal coverage information from the OAM. The second signal coverage information can be pre-stored in the OAM network element by the NTN-RAN device, etc.

Here, the UE Configuration Update (UCU) event can be performed by the core network device to trigger that the core network device transmits a message carrying the second signal coverage information to the UE.

When the UE leaves the current signal coverage, the core network can update the UE configuration for the UE, such as updating the power-saving parameters of the UE, based on the interval between the time the UE re-enters into the signal coverage and the time the UE leaves the signal coverage. The power-saving parameters may include at least one of: the starting time when the UE enters the power-saving mode, the starting time when the UE returns from the power-saving mode to the normal working mode, or the duration for which the UE maintains the power-saving mode. The power-saving mode may include the CM-IDLE status of the UE, etc. In the power-saving mode, the UE does not transmit any uplink signaling requests to save power.

The core network device can use a secure transmission method to transmit a message carrying second signal coverage information. Here, the secure transmission method may include using encryption protection and/or integrity protection to transmit messages. Since the message carrying the second signal coverage information is a protected message, it can be considered that the second signal coverage information has not been tampered with during transmission. The second signal coverage information can be considered as the true signal coverage information.

For example, the core network device can carry the second signal coverage information through an NAS message transmitted to the UE during the UE configuration update process. The NAS message is encrypted and/or integrity protected, which can reduce errors in the transmission of the second signal coverage information.

The UE can compare the first signal coverage information with the second signal coverage information to determine whether the received first signal coverage information is the true signal coverage information of the satellite.

The third signal coverage information can be determined based on whether the first signal coverage information is true signal coverage information. For example, if the first signal coverage information is true signal coverage information, the third signal coverage information can be determined based on the first signal coverage information. If the first signal coverage information is untrue signal coverage information, the second signal coverage information can be determined as the third signal coverage information.

The UE can determine its location within the satellite signal coverage based on the third signal coverage information, and then determine whether to perform data communication and/or stop data communication.

In this way, by comparing the first signal coverage information with the second signal coverage information obtained through a secure transmission method, it is determined whether the first signal coverage information is correct, and then based on the determined true third signal coverage information of the satellite, communication is carried out with the NTN-RAN device to improve communication security, which can reduce the situation where incorrect signal coverage information is used to mislead the UE to stop working within the actual network coverage, or to reduce unnecessary power consumption caused by the UE continuing to transmit signals to access the network beyond the actual network coverage.

In an embodiment, transmitting a (Non-Access Stratum) NAS message carrying second signal coverage information to the UE includes:

transmitting a UE configuration update message carrying the second signal coverage information to the UE.

In an embodiment, receiving the second signal coverage information transmitted by the NTN-RAN device includes:

receiving a context release request message carrying the second signal coverage information transmitted by the NTN-RAN device.

For example, if the NTN-RAN device detects that the UE is to leave the current network coverage based on signal coverage information, the NTN-RAN device can trigger an AN release process to move the UE to the CM-IDLE state before the UE leaves the current network coverage. The NTN-RAN device transmits a context release request message (N2 UE Context Release Request) to AMF. In the N2 UE context release request message, the NTN-RAN can transmit the fourth signal coverage information to AMF. Since the N2 message is a protected message, it can be considered that the second signal coverage information obtained by AMF from the registration request message is consistent with the fourth signal coverage information. AMF can also obtain the second signal coverage information from OAM. AMF can store the obtained second signal coverage information.

If the NTN-RAN does not transmit signal coverage information to AMF, AMF can obtain the second signal coverage information from the OAM webpage. If AMF detects that the UE is to leave the current network coverage based on the second signal coverage information, when the UE is still within the network coverage, the AMF triggers the AN release process to move the UE to the CM-IDLE state. AMF can determine the power-saving parameters of UE based on second signal coverage information. The power-saving parameters can indicate that the UE remains in the power-saving mode without waking up or transmitting any uplink signaling requests in the absence of network coverage.

AMF triggers the UE configuration update process to update power-saving parameters. AMF transmits a UE configuration update message to the UE. The UE configuration update message carries second signal coverage information. The UE configuration update message is an NAS message. The NAS message is protected by security measures. Therefore, the UE can correctly receive the second signal coverage information.

By carrying the second signal coverage information in the UE configuration update message, the accuracy of UE receiving the second signal coverage information can be improved, and the verification of the first signal coverage information can be achieved.

In an embodiment, determining, by the UE based on the first signal coverage information and the second signal coverage information, the third signal coverage information to be used by the UE includes:

determining, by the UE in response to the first signal coverage information and the second signal coverage information being same, the first signal coverage information as the third signal coverage information; or

determining, by the UE in response to the first signal coverage information and the second signal coverage information being different, the second signal coverage information as the third signal coverage information.

For example, the UE compares the first signal coverage information with the second signal coverage information. If the first signal coverage information is inconsistent with the second signal coverage information, the UE can use the second signal coverage information as the third signal coverage information. For example, the second signal coverage information can be used to cover the first signal coverage information stored by the UE. If the first signal coverage information is consistent with the second signal coverage information, the UE can use the first signal coverage information as the third signal coverage information. For example, the first signal coverage information can be retained.

As shown in FIG. 5, this embodiment provides a signal coverage information determining method, which can be performed by a core network device in a cellular mobile communication system, and includes step 501.

In step 501, an N2 UE context release command is transmitted to an NTN-RAN device, where the N2 UE context release command is configured to trigger the NTN-RAN device to transmit an access network connection release request to the UE, where the access network connection release request instructs the UE to release an access network connection.

Step 501 can be implemented separately or in combination with steps 401 to 402.

After a core network device (such as AMF) transmits the UE configuration update message to the UE, the core network device (such as AMF) can transmit the N2 UE Context Release Command to the NTN-RAN. After the N2 UE context release command is received, the NTN-RAN can request the UE to release the access network connection through an access network connection release request. After the RAN connection release confirmation is received from the UE, the NTN-RAN deletes the context of the UE. The NTN-RAN confirms N2 release by returning an N2 UE Context Release Complete message to AMF.

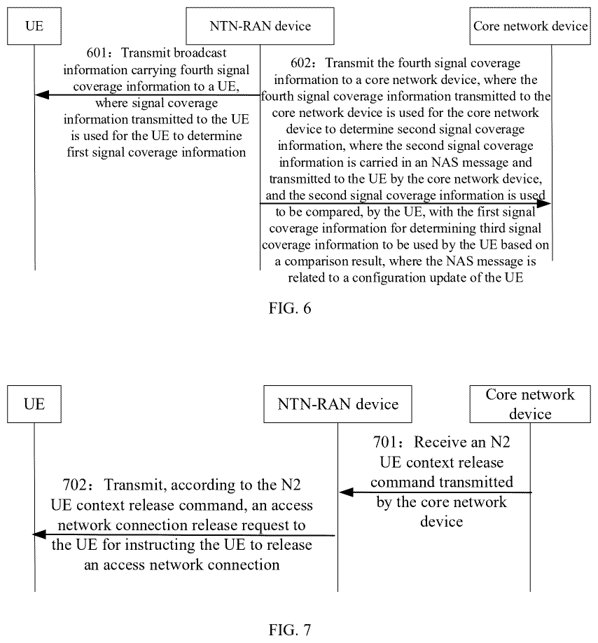

As shown in FIG. 6, this embodiment provides a signal coverage information determining method, which can be performed by an NTN-RAN device in a cellular mobile communication system, and includes steps 601 and 602.

In step 601, broadcast information carrying fourth signal coverage information is transmitted to a UE, where signal coverage information transmitted to the UE is used for the UE to determine first signal coverage information.

In step 602, the fourth signal coverage information is transmitted to a core network device, where the fourth signal coverage information transmitted to the core network device is used for the core network device to determine second signal coverage information, where the second signal coverage information is carried in an NAS message and transmitted to the UE by the core network device, and the second signal coverage information is used to be compared, by the UE, with the first signal coverage information for determining third signal coverage information to be used by the UE based on a comparison result, where the NAS message is related to a configuration update of the UE.

This embodiment can be applied, but is not limited to, scenarios with discontinuous satellite signal coverage, which is not limited in the present disclosure.

The NTN-RAN device can include a satellite, or a base station, etc. in the NTN. In the NTN, a satellite can be used to provide a relay for signals of a base station, i.e., to provide signal coverage for the cellular mobile communication network to the ground. Alternatively, the satellite can also be an aerial base station in NTN, to provide signal coverage for the cellular mobile communication network to the ground.

Signal coverage information, i.e., satellite signal coverage information, can be used to determine the coverage of satellite signals at different times. The signal coverage information includes but is not limited to at least one of the following: ephemeris information of a satellite, a center position of satellite signal coverage, a coverage radius of satellite signals, or a coverage area of satellite signals, etc.

A UE can determine the location of the UE within the satellite signal coverage based on signal coverage information. For example, the UE can determine the current distance from the center point of the satellite signal coverage to the UE or the current distance from the edge of the satellite signal coverage to the UE based on the geographical location of the UE, satellite ephemeris, a center position of satellite signal coverage, and a radius of satellite signal coverage. Furthermore, the UE can determine whether to access the network, perform data communication, and/or stop data communication.

The first signal coverage information may be the signal coverage information obtained by the UE from the broadcast information of the NTN-RAN device.

In an embodiment, the broadcast information may include but is not limited to system information broadcasted by the NTN-RAN device. The system information includes but is not limited to SIB. Signal coverage information herein can be configured by OAM on the NTN-RAN device.

The NTN-RAN device can carry the true signal coverage information (i.e., fourth signal coverage information) of a satellite in the broadcast information for broadcasting. Due to the possibility of erroneous transmission and/or tampering during the transmission of broadcast system information, the fourth signal coverage information transmitted by the NTN-RAN device may differ from the first signal coverage information obtained by UE from the broadcast information. The first signal coverage information may be the same as the fourth signal coverage information carried by the NTN-RAN device in the broadcast information, or the first signal coverage information may be different from the fourth signal coverage information carried by the NTN-RAN device in the broadcast information.

For example, since the broadcast system information is not tamper-protected, the fourth signal coverage information carried by the NTN-RAN device in the broadcast information may be tampered with, causing the first signal coverage information received by the UE to be different from the fourth signal coverage information.

The core network device herein can include AMF, etc. The core network device can obtain the second signal coverage information. The core network device can be set to obtain second signal coverage information through a protected channel to improve the reliability of the second signal coverage information.

In an embodiment, the core network device obtaining the second signal coverage information, includes at least one of the following:

the core network device receiving the second signal coverage information transmitted by a Non-Terrestrial Networks-Radio Access Network (NTN-RAN) device; or

the core network device obtaining the second signal coverage information pre-stored from an (Operation Administration and Maintenance) OAM network element.

The NTN-RAN device can carry fourth signal coverage information through an N2 message, and the core network device can obtain carried second signal coverage information from the N2 message. Since the N2 message is a protected message, there is a high probability that the fourth signal coverage information matches the second signal coverage information received by the core network device. It is generally believed that the fourth signal coverage information is protected by security measures during transmission, such as encryption protection and/or integrity protection. Therefore, the second signal coverage information received by the core network device is consistent with the fourth signal coverage information.

The second signal coverage information can also be pre-stored in the OAM network element. The core network device can directly obtain the second signal coverage information from the OAM. The second signal coverage information can be pre-stored in the OAM network element by the NTN-RAN device, etc.

Here, the UE Configuration Update (UCU) event can be performed by the core network device to trigger that the core network device transmits a message carrying the second signal coverage information to the UE.

When the UE leaves the current signal coverage, the core network can update the UE configuration for the UE, such as updating the power-saving parameters of the UE, based on the interval between the time the UE re-enters into the signal coverage and the time the UE leaves the signal coverage. The power-saving parameters may include at least one of: the starting time when the UE enters the power-saving mode, the starting time when the UE returns from the power-saving mode to the normal working mode, or the duration for which the UE maintains the power-saving mode. The power-saving mode may include the CM-IDLE status of the UE, etc. In the power-saving mode, the UE does not transmit any uplink signaling requests to save power.

The core network device can use a secure transmission method to transmit a message carrying second signal coverage information. Here, the secure transmission method may include using encryption protection and/or integrity protection to transmit messages. Since the message carrying the second signal coverage information is a protected message, it can be considered that the second signal coverage information has not been tampered with during transmission. The second signal coverage information can be considered as the true signal coverage information.

For example, the core network device can carry the second signal coverage information through an NAS message transmitted to the UE during the UE configuration update process. The NAS message is encrypted and/or integrity protected, which can reduce errors in the transmission of the second signal coverage information.

The UE can compare the first signal coverage information with the second signal coverage information to determine whether the received first signal coverage information is the true signal coverage information of the satellite.

The third signal coverage information can be determined based on whether the first signal coverage information is true signal coverage information. For example, if the first signal coverage information is true signal coverage information, the third signal coverage information can be determined based on the first signal coverage information. If the first signal coverage information is untrue signal coverage information, the second signal coverage information can be determined as the third signal coverage information.

The UE can determine its location within the satellite signal coverage based on the third signal coverage information, and then determine whether to perform data communication and/or stop data communication.

In this way, by comparing the first signal coverage information with the second signal coverage information obtained through a secure transmission method, it is determined whether the first signal coverage information is correct, and then based on the determined true third signal coverage information of the satellite, communication is carried out with the NTN-RAN device to improve communication security, which can reduce the situation where incorrect signal coverage information is used to mislead the UE to stop working within the actual network coverage, or to reduce unnecessary power consumption caused by the UE continuing to transmit signals to access the network beyond the actual network coverage.

In an embodiment, transmitting the fourth signal coverage information to the core network device includes:

transmitting a context release request message carrying the fourth signal coverage information to the core network device.

For example, if the NTN-RAN device detects that the UE is to leave the current network coverage based on signal coverage information, the NTN-RAN device can trigger an AN release process to move the UE to the CM-IDLE state before the UE leaves the current network coverage. The NTN-RAN device transmits a context release request message (N2 UE Context Release Request) to AMF. In the N2 UE context release request message, the NTN-RAN can transmit the fourth signal coverage information to AMF. Since the N2 message is a protected message, it can be considered that the second signal coverage information obtained by AMF from the registration request message is consistent with the fourth signal coverage information. AMF can also obtain the second signal coverage information from OAM. AMF can store the obtained second signal coverage information.

If the NTN-RAN does not transmit signal coverage information to AMF, AMF can obtain the second signal coverage information from the OAM webpage. If AMF detects that the UE is to leave the current network coverage based on the second signal coverage information, when the UE is still within the network coverage, the AMF triggers the AN release process to move the UE to the CM-IDLE state.

In an embodiment, receiving, by the UE, the NAS message carrying the second signal coverage information transmitted by the core network device includes:

receiving, by the UE, a UE configuration update message carrying the second signal coverage information transmitted by the core network device.

AMF can determine the power-saving parameters of UE based on second signal coverage information. The power-saving parameters can indicate that the UE remains in the power-saving mode without waking up or transmitting any uplink signaling requests in the absence of network coverage.

AMF triggers the UE configuration update process to update power-saving parameters. AMF transmits a UE configuration update message to the UE. The UE configuration update message carries second signal coverage information. The UE configuration update message is an NAS message. The NAS message is protected by security measures. Therefore, the UE can correctly receive the second signal coverage information.

By carrying the second signal coverage information in the UE configuration update message, the accuracy of UE receiving the second signal coverage information can be improved, and the verification of the first signal coverage information can be achieved.

In an embodiment, determining, by the UE based on the first signal coverage information and the second signal coverage information, the third signal coverage information to be used by the UE includes:

determining, by the UE in response to the first signal coverage information and the second signal coverage information being same, the first signal coverage information as the third signal coverage information; or

determining, by the UE in response to the first signal coverage information and the second signal coverage information being different, the second signal coverage information as the third signal coverage information.

For example, the UE compares the first signal coverage information with the second signal coverage information. If the first signal coverage information is inconsistent with the second signal coverage information, the UE can use the second signal coverage information as the third signal coverage information. For example, the second signal coverage information can be used to cover the first signal coverage information stored by the UE. If the first signal coverage information is consistent with the second signal coverage information, the UE can use the first signal coverage information as the third signal coverage information. For example, the first signal coverage information can be retained.

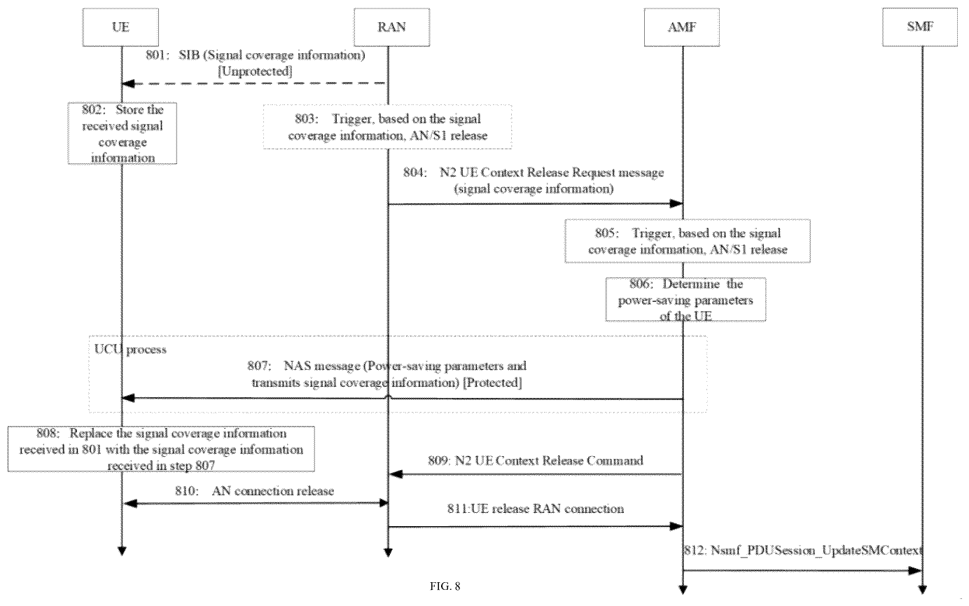

As shown in FIG. 7, this embodiment provides a signal coverage information determining method, which can be performed by an NTN-RAN device in a cellular mobile communication system, and includes steps 701 and 702.

In step 701, an N2 UE context release command transmitted by the core network device is received.

In step 702, according to the N2 UE context release command, an access network connection release request is transmitted to the UE for instructing the UE to release an access network connection.

Step 701 and Step 702 can be implemented separately or in combination with steps 601 to 602.

After a core network device (such as AMF) transmits the UE configuration update message to the UE, the core network device (such as AMF) can transmit the N2 UE Context Release Command to the NTN-RAN. After the N2 UE context release command is received, the NTN-RAN can request the UE to release the access network connection through an access network connection release request. After the RAN connection release confirmation is received from the UE, the NTN-RAN deletes the context of the UE. The NTN-RAN confirms N2 release by returning an N2 UE Context Release Complete message to AMF.

The following provides a specific example in combination with any of the above embodiments.

As shown in FIG. 8, the specific steps for the UE to verify the signal coverage information (first signal coverage information) obtained from the broadcast information by the signal coverage information (second signal coverage information) provided by AMF include following steps.

In step 801, the NTN-RAN (NTN-RAN device) transmits signal coverage information (fourth signal coverage information) to the UE when broadcasting SIB information. The signal coverage information (fourth signal coverage information) in SIB information is not protected. The signal coverage information (fourth signal coverage information) herein can be configured on the NTN-RAN by the OAM system.

In step 802, the UE stores the received signal coverage information (first signal coverage information).

In step 803, if the NTN-RAN detects that the UE is to leave the current network coverage based on the signal coverage information (fourth signal coverage information), the NTN-RAN can trigger the AN release process to move the UE to the CM-IDLE state before the UE leaves the current network coverage.

In step 804, the NTN-RAN transmits an N2 UE Context Release Request message to AMF, where in N2 UE Context Release Request message, the NTN-RAN can transmit signal coverage information (fourth signal coverage information) to AMF. The AMF receives signal coverage information (second signal coverage information, usually considered to be the same as fourth signal coverage information) from the N2 UE context release request message.

In step 805, if the NTN-RAN does not transmit signal coverage information (fourth signal coverage information) to AMF, AMF can obtain signal coverage information (second signal coverage information) from the OAM webpage. If the AMF detects that the UE is to leave the current network coverage based on the signal coverage information (second signal coverage information), when the UE is still within the network coverage, the AMF triggers the AN release process to move the UE to the CM-IDLE state.

In step 806, the AMF determines the power-saving parameters of the UE based on the signal coverage information. This is to ensure that the UE remains in the power-saving mode without waking up or transmitting any uplink signaling requests in the absence of network coverage.

In step 807, the AMF triggers the UE Configuration Update (UCU) process to update the power-saving parameters. Meanwhile, the AMF also transmits signal coverage information (second signal coverage information) to the UE during the UCU process, where the signal coverage information is protected by NAS security.

In step 808, the UE compares the signal coverage information (second signal coverage information) received in step 807 with the signal coverage information (first signal coverage information) received in step 801. If the signal coverage information (second signal coverage information) received in step 807 is inconsistent with the signal coverage information (first signal coverage information) received in step 801, the UE will replace the signal coverage information (first signal coverage information) (unprotected) received in 801 with the signal coverage information (second signal coverage information) newly received in step 807.

In step 809, the AMF transmits N2 UE Context Release Command to the NTN-RAN.

In step 810, the NTN-RAN requests the UE to release RAN connection. After the RAN connection release confirmation is received from the UE, the NTN-RAN deletes the context of the UE.

In step 811, the NTN-RAN confirms N2 release by returning an N2 UE Context Release Complete message to AMF.

In step 812, the AMF invokes the Nsmf_PDUSession_UpdateSMContext request to the SMF (Session Management Function) to release the N3 resources for each PDU (Packet Data Unit) session in the N2 UE context release complete message.

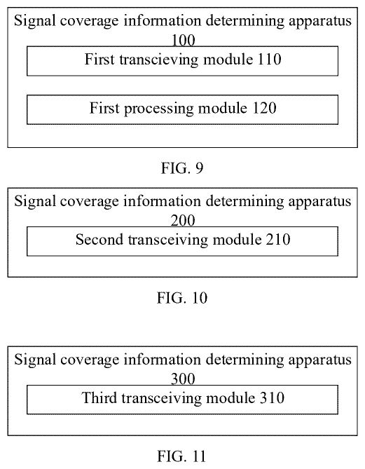

The embodiments of the present disclosure further provide a signal coverage information determining apparatus, as shown in FIG. 9, applied to a UE in cellular mobile wireless communication, where the apparatus 100 includes:

a first transceiving module 110, configured to receive broadcast information carrying first signal coverage information transmitted by a Non-Terrestrial Networks-Radio Access Network (NTN-RAN) device;

where the first transceiving module 110 is further configured to receive a Non-Access Stratum (NAS) message carrying second signal coverage information transmitted by a core network device, where the NAS message is related to a configuration update of a user equipment (UE); and

a processing module 120, configured to determine, based on the first signal coverage information and the second signal coverage information, third signal coverage information to be used by the UE.

In an embodiment, the first transceiving module 110 is specifically configured to:

receive a UE configuration update message carrying the second signal coverage information transmitted by the core network device.

In an embodiment, the processing module 120 is specifically configured to:

determine, in response to the first signal coverage information and the second signal coverage information being same, the first signal coverage information as the third signal coverage information; or

determine, in response to the first signal coverage information and the second signal coverage information being different, the second signal coverage information as the third signal coverage information.

In an embodiment, the processing module 120 is further configured to:

release an access network connection based on an access network connection release request transmitted by the NTN-RAN device.

The embodiments of the present disclosure further provide a signal coverage information determining apparatus, as shown in FIG. 10, applied to a core network device in cellular mobile wireless communication, where the apparatus 200 includes:

a second transceiving module 210, configured to obtain second signal coverage information;

where the second transceiving module 210 is configured to transmit a Non-Access Stratum (NAS) message carrying the second signal coverage information to a user equipment (UE), where the NAS message is related to a configuration update of the UE, where the second signal coverage information is used to be compared, by the UE, with first signal coverage information determined by the UE from broadcast information, for determining third signal coverage information to be used by the UE based on a comparison result.

In an embodiment, the second transceiving module 210 is specifically configured to:

transmit a UE configuration update message carrying the second signal coverage information to the UE.

In an embodiment, the second transceiving module 210 is further configured to at least one of:

receive the second signal coverage information transmitted by a Non-Terrestrial Networks-Radio Access Network (NTN-RAN) device; or

obtain the second signal coverage information pre-stored from an (Operation Administration and Maintenance) OAM network element.

In an embodiment, the second transceiving module 210 is specifically configured to:

receive a context release request message carrying the second signal coverage information transmitted by the NTN-RAN device.

In an embodiment, the second transceiving module 210 is further configured to transmit an N2 UE context release command to an NTN-RAN device, where the N2 UE context release command is configured to trigger the NTN-RAN device to transmit an access network connection release request to the UE, where the access network connection release request instructs the UE to release an access network connection.

The embodiments of the present disclosure further provide a signal coverage information determining apparatus, as shown in FIG. 11, applied to an NTN-RAN device in cellular mobile wireless communication, where the apparatus 300 includes:

a third transceiving module 310, configured to transmit broadcast information carrying fourth signal coverage information to a user equipment (UE), where signal coverage information transmitted to the UE is used for the UE to determine first signal coverage information;

where the third transceiving module 310 is further configured to transmit the fourth signal coverage information to a core network device, where the fourth signal coverage information transmitted to the core network device is used for the core network device to determine second signal coverage information, where the second signal coverage information is carried in a Non-Access Stratum (NAS) message and transmitted to the UE by the core network device, and the second signal coverage information is used to be compared, by the UE, with the first signal coverage information for determining third signal coverage information to be used by the UE based on a comparison result, where the NAS message is related to a configuration update of the UE.

In an embodiment, the third transceiving module 310 is specifically configured to:

transmit a context release request message carrying the fourth signal coverage information to the core network device.

In an embodiment, the third transceiving module 310 is further configured to:

receive an N2 UE context release command transmitted by the core network device; and

transmit, according to the N2 UE context release command, an access network connection release request to the UE for instructing the UE to release an access network connection.

In an embodiment, the first transceiving module 110, the first processing module 120, the second transceiving module 210, and the third transceiving module 310 may be implemented through one or more central processing units (CPUs), Graphics Processing Units (GPUs), baseband processors (BPs), application specific integrated circuits (ASICs), DSPs, Programmable Logic Devices (PLDs), Complex Programmable Logic Devices (CPLDs), Field Programmable Gate Arrays (FPGAs), General purpose processors, controllers, micro controller units (MCUs), Microprocessors or other electronic components, to perform the aforementioned methods.

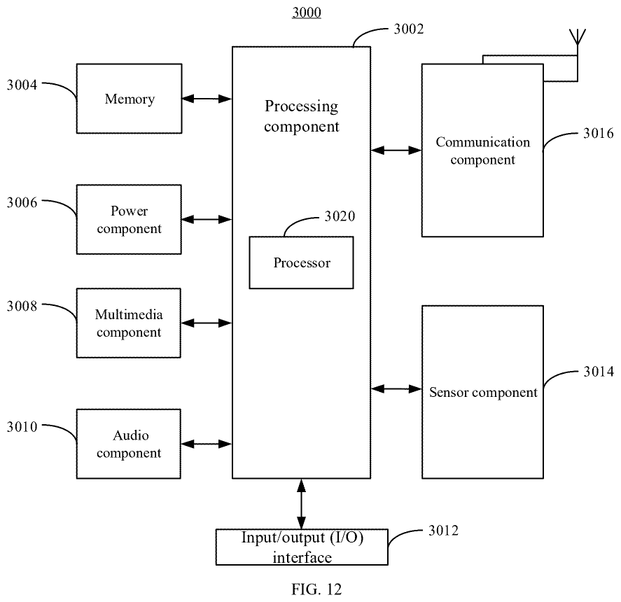

FIG. 12 is a block diagram of a device 3000 for signal coverage information determination according to an embodiment. For example, device 3000 can be a mobile phone, a computer, a digital broadcast terminal, a message transmitting and receiving device, a gaming console, a tablet device, a medical device, a fitness device, a personal digital assistant, and the like.

As shown in FIG. 12, the apparatus 3000 may include one or more of the following components: a processing component 3002, a memory 3004, a power supply component 3006, a multimedia component 3008, an audio component 3010, an input/output (I/O) interface 3012, a sensor component 3014, and a communication component 3016.

The processing component 3002 generally controls the overall operations of the electronic device 3000, such as operations associated with display, calling, data communication, camera operation and recording operation. The processing assembly 3002 may include one or more processors 3020 to execute instructions to complete all or a part of the blocks of the above methods. Further, the processing component 3002 may include one or more modules to facilitate interaction between the processing component 3002 and another component. For example, the processing component 3002 may include a multimedia module to facilitate the interaction between the multimedia component 3008 and the processing component 3002.

The memory 3004 is configured to store different types of data to support the operations of the electronic device 3000. Examples of such data include instructions of any application program or method operable on the electronic device 3000, contact data, telephone directory data, messages, pictures, videos, and the like. The memory 3004 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 3006 provides power for different components of the electronic device 3000. The power supply component 3006 may include a power management system, one or more power sources, and other components associated with generating, managing and distributing power for the electronic device 3000.

The multimedia component 3008 includes a screen providing an output interface between the apparatus 3000 and the user. In some examples, the screen may include a Liquid Crystal Display (LCD) and a Touch Panel (TP). If the screen includes a touch panel, the screen may be implemented as a touch screen for receiving an input signaling from a user. The touch panel may include one or more touch sensors for sensing a touch, a slide and a gesture on the touch panel.

The touch sensor may not only sense the boundary of a touch or slide operation but also detect duration and pressure relating to the touch or slide operation. In some examples, the multimedia component 3008 may include a front camera and/or a rear camera. When the device 3000 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 3010 is configured to output and/or input an audio signaling. For example, the audio component 3010 may include a microphone (MIC). When the electronic device 3000 is in an operating mode, such as a call mode, a recording mode and a speech recognition mode, the microphone is configured to receive an external audio signal. The received audio signaling may be further stored in the memory 3004 or transmitted via the communication component 3016. In some examples, the audio component 3010 also includes a loudspeaker for outputting an audio signaling.

The I/O interface 3012 provides an interface between the processing component 3002 and a peripheral interface module which may be a keyboard, a click wheel, a button, or the like. These buttons may include but not limited to, a home button, a volume button, a start button and a lock button.

The sensor component 3014 may include one or more sensors for providing state assessments in different aspects for the electronic device 3000. For example, the sensor component 3014 may detect the on/off status of the apparatus 3000, and relative signal coverage information of component, for example, the component is a display and a keypad of the apparatus 3000. The sensor component 3014 may also detect a change in position of the apparatus 3000 or a component of the apparatus 3000, a presence or absence of the contact between a user and the apparatus 3000, an orientation or an acceleration/deceleration of the apparatus 3000, and a change in temperature of the apparatus 3000. The sensor component 3014 may include a proximity sensor for detecting the existence of a nearby object without any physical touch. The sensor component 3014 may also include an optical sensor, such as a CMOS or CCD image sensor used in an imaging application. In some examples, the sensor component 3014 may also include an acceleration sensor, a gyro sensor, a magnetic sensor, a pressure sensor, or a temperature sensor.

The communication component 3016 is configured to facilitate wired or wireless communication between the electronic device 3000 and other devices. Device 3000 can access a wireless network according to a communication standard, such as Wi-Fi, 2G, 3G, 4G, 5G, 3G, or any combination thereof. In some embodiments, the communication component 3016 may receive a broadcast signaling or broadcast-related information from an external broadcast management system via a broadcast channel. In some embodiments, the communication assembly 3016 may also include a Near Field Communication (NFC) module to facilitate short-range communications. For example, the NFC module may be implemented according to a Radio Frequency Identification (RFID) technology, an Infrared Data Association (IrDA) technology, an Ultra-Wideband (UWB) technology, a Bluetooth® (BT) technology and other technologies.

In an example, the apparatus 3000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components for performing the method described above.

In an example, a non-transitory computer readable storage medium including instructions, such as the memory 3004 including instructions, is also provided. The above instructions may be executed by the processor 3020 of the apparatus 3000 to complete the above method. For example, the non-transitory computer-readable storage medium may be a ROM, a RAM, a CD-ROM, a magnetic tape, a floppy disc, an optical data storage device, and the like.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the art that are not disclosed in the present disclosure. The specification and embodiments herein are intended to be illustrative only and the real scope and spirit of the present disclosure are indicated by the claims of the present disclosure.

It is to be understood that the present disclosure is not limited to the precise structures described above and shown in the accompanying drawings and can be modified or changed without departing from the scope of the present disclosure. The scope of protection of the present disclosure is limited only by the appended claims.

1. A signal coverage information determining method, performed by a user equipment (UE), comprising:
receiving broadcast information carrying first signal coverage information transmitted by a Non-Terrestrial Networks-Radio Access Network (NTN-RAN) device;
receiving a Non-Access Stratum (NAS) message carrying second signal coverage information transmitted by a core network device, wherein the NAS message is related to a configuration update of the UE; and
determining, based on the first signal coverage information and the second signal coverage information, third signal coverage information to be used by the UE.

2. The method according to claim 1, wherein receiving the NAS message carrying the second signal coverage information transmitted by the core network device comprises:
receiving a UE configuration update message carrying the second signal coverage information transmitted by the core network device.

3. The method according to claim 1 or 2, wherein determining, based on the first signal coverage information and the second signal coverage information, the third signal coverage information to be used by the UE comprises:
determining, in response to the first signal coverage information and the second signal coverage information being same, the first signal coverage information as the third signal coverage information; or
determining, in response to the first signal coverage information and the second signal coverage information being different, the second signal coverage information as the third signal coverage information.

4. The method according to claim 1 or 2, further comprising:
releasing an access network connection based on an access network connection release request transmitted by the NTN-RAN device.

5. A signal coverage information determining method, performed by a core network device, comprising:
obtaining second signal coverage information; and
transmitting a Non-Access Stratum (NAS) message carrying the second signal coverage information to a user equipment (UE), wherein the NAS message is related to a configuration update of the UE, wherein the second signal coverage information is used to be compared, by the UE, with first signal coverage information determined by the UE from broadcast information, for determining third signal coverage information to be used by the UE based on a comparison result.

6. The method according to claim 5, wherein transmitting the NAS message carrying the second signal coverage information to the UE comprises:
transmitting a UE configuration update message carrying the second signal coverage information to the UE.

7. The method according to claim 5, wherein obtaining the second signal coverage information comprises at least one of:
receiving the second signal coverage information transmitted by a Non-Terrestrial Networks-Radio Access Network (NTN-RAN) device; or
obtaining the second signal coverage information pre-stored from an (Operation Administration and Maintenance) OAM network element.

8. The method according to claim 7, wherein receiving the second signal coverage information transmitted by the NTN-RAN device comprises:
receiving a context release request message carrying the second signal coverage information transmitted by the NTN-RAN device.

9. The method according to any one of claims 5 to 8, further comprising:
transmitting an N2 UE context release command to an NTN-RAN device, wherein the N2 UE context release command is configured to trigger the NTN-RAN device to transmit an access network connection release request to the UE, and the access network connection release request instructs the UE to release an access network connection.

10. A signal coverage information determining method, performed by a Non-Terrestrial Networks-Radio Access Network (NTN-RAN) device, comprising:
transmitting broadcast information carrying fourth signal coverage information to a user equipment (UE), wherein signal coverage information transmitted to the UE is used for the UE to determine first signal coverage information; and
transmitting the fourth signal coverage information to a core network device, wherein the fourth signal coverage information transmitted to the core network device is used for the core network device to determine second signal coverage information, wherein the second signal coverage information is carried in a Non-Access Stratum (NAS) message and transmitted to the UE by the core network device, and the second signal coverage information is used to be compared, by the UE, with the first signal coverage information for determining third signal coverage information to be used by the UE based on a comparison result, wherein the NAS message is related to a configuration update of the UE.

11. The method according to claim 10, wherein transmitting the fourth signal coverage information to the core network device comprises:
transmitting a context release request message carrying the fourth signal coverage information to the core network device.

12. The method according to claim 10 or 11, further comprising:
receiving an N2 UE context release command transmitted by the core network device; and
transmitting, according to the N2 UE context release command, an access network connection release request to the UE for instructing the UE to release an access network connection.

13. A signal coverage information determining apparatus, comprising:
a first transceiving module, configured to receive broadcast information carrying first signal coverage information transmitted by a Non-Terrestrial Networks-Radio Access Network (NTN-RAN) device;
wherein the first transceiving module is further configured to receive a Non-Access Stratum (NAS) message carrying second signal coverage information transmitted by a core network device, wherein the NAS message is related to a configuration update of a user equipment (UE); and
a processing module, configured to determine, based on the first signal coverage information and the second signal coverage information, third signal coverage information to be used by the UE.

14. The apparatus according to claim 13, wherein the first transceiving module is configured to:
receive a UE configuration update message carrying the second signal coverage information transmitted by the core network device.

15. The apparatus according to claim 13 or 14, wherein the processing module is configured to:
determine, in response to the first signal coverage information and the second signal coverage information being same, the first signal coverage information as the third signal coverage information; or
determine, in response to the first signal coverage information and the second signal coverage information being different, the second signal coverage information as the third signal coverage information.

16. The apparatus according to claim 13 or 14, wherein the processing module is further configured to:
release an access network connection based on an access network connection release request transmitted by the NTN-RAN device.

17. A signal coverage information determining apparatus, comprising:
a second transceiving module, configured to obtain second signal coverage information;
wherein the second transceiving module is configured to transmit a Non-Access Stratum (NAS) message carrying the second signal coverage information to a user equipment (UE), wherein the NAS message is related to a configuration update of the UE, wherein the second signal coverage information is used to be compared, by the UE, with first signal coverage information determined by the UE from broadcast information, for determining third signal coverage information to be used by the UE based on a comparison result.

18. The apparatus according to claim 17, wherein the second transceiving module is configured to:
transmit a UE configuration update message carrying the second signal coverage information to the UE.

19. The apparatus according to claim 17, wherein the second transceiving module is further configured to at least one of:
receive the second signal coverage information transmitted by a Non-Terrestrial Networks-Radio Access Network (NTN-RAN) device; or
obtain the second signal coverage information pre-stored from an (Operation Administration and Maintenance) OAM network element.

20. The apparatus according to claim 19, wherein the second transceiving module is configured to:
receive a context release request message carrying the second signal coverage information transmitted by the NTN-RAN device.

21. The apparatus according to any one of claims 17 to 20, wherein the second transceiving module is further configured to transmit an N2 UE context release command to an NTN-RAN device, wherein the N2 UE context release command is configured to trigger the NTN-RAN device to transmit an access network connection release request to the UE, and the access network connection release request instructs the UE to release an access network connection.

22. A signal coverage information determining apparatus, comprising:
a third transceiving module, configured to transmit broadcast information carrying fourth signal coverage information to a user equipment (UE), wherein signal coverage information transmitted to the UE is used for the UE to determine first signal coverage information;
wherein the third transceiving module is further configured to transmit the fourth signal coverage information to a core network device, wherein the fourth signal coverage information transmitted to the core network device is used for the core network device to determine second signal coverage information, wherein the second signal coverage information is carried in a Non-Access Stratum (NAS) message and transmitted to the UE by the core network device, and the second signal coverage information is used to be compared, by the UE, with the first signal coverage information for determining third signal coverage information to be used by the UE based on a comparison result, wherein the NAS message is related to a configuration update of the UE.

23. The apparatus according to claim 22, wherein the third transceiving module is configured to:
transmit a context release request message carrying the fourth signal coverage information to the core network device.

24. The apparatus according to claim 22 or 23, wherein the third transceiving module is further configured to:
receive an N2 UE context release command transmitted by the core network device; and
transmit, according to the N2 UE context release command, an access network connection release request to the UE for instructing the UE to release an access network connection.

25. A communication device, comprising one or more processors, one or more memories, and an executable program stored on the one or more memories and executable by the one or more processors, wherein the one or more processors, when running the executable program, implement the signal coverage information determining method according to any one of claims 1 to 4, or 5 to 9, or 10 to 12.

26. A storage medium storing an executable program, wherein when the executable program is executed by one or more processors, the signal coverage information determining method according to any one of claims 1 to 4, or 5 to 9, or 10 to 12 is implemented.
